(19) United States
(12) Patent Application Publication
(10) Pub. No.: US 2011/0290136 A1
(43) Pub. Date: Dec. 1, 2011

(54) LITHOGRAPHIC APPARATUS AND MANUFACTURING METHOD OF COMMODITIES

(75) Inventor: Shinichiro Koga, Utsunomiya-shi (JP)

(73) Assignee: CANON KABUSHIKI KAISHA, Tokyo (JP)

(21) Appl. No.: 13/117,645

(22) Filed: May 27, 2011

(30) Foreign Application Priority Data
May 31, 2010 (JP) 2010-124614

(51) Int. Cl. B41F 1/34

(52) U.S. Cl. 101/481; 101/485

(57) ABSTRACT

The present invention provides a lithographic apparatus includes a first detection unit for detecting a first mark formed on an original and a second mark formed in each of a plurality of shot regions on a substrate, a second detection unit for detecting the second mark, and a processing unit for performing a process of detecting the second mark by the second detection unit to obtain an array of the shot regions, a process of obtaining a positional relationship between the first mark and the second mark, which are detected by the first detection unit, for each of the shot regions upon moving the substrate using the result of obtaining the array of the shot regions, and a process of transferring a pattern of the original onto each of the shot regions upon aligning the original and the substrate for each of the shot regions based on the positional relationship.

### BACKGROUND OF THE INVENTION

1. Field of the Invention

The present invention relates to a lithographic apparatus and a manufacturing method of commodities.

2. Description of the Related Art

In recent years, imprint techniques which can form micropatterns are attracting a great deal of attention as techniques for manufacturing various kinds of devices (for example, a semiconductor device such as an IC and an LSI, a liquid crystal device, an image sensing device such as a CCD, and a magnetic head). In the imprint techniques, a micropattern formed on an original (mold) is transferred onto a substrate such as a silicon wafer or a glass plate by curing a resin on the substrate while the resin and the original are kept in contact with each other.

The imprint techniques provide several types of resin curing methods, and the photocuring method is known as one of these resin curing methods. In the photocuring method, an ultraviolet-curable resin is irradiated with ultraviolet rays while the resin and a transparent mold are kept in contact with each other to perform light exposure and curing of the resin, and thereupon the mold is separated (released). An imprint technique which uses the photocuring method is suitable for manufacturing devices because it can relatively easily control the temperature and can detect, for example, alignment marks, which are formed on a substrate, via a mold.

As a lithographic apparatus (imprint apparatus) which uses an imprint technique, an apparatus to which step-and-flash imprint lithography (SFIL) is applied is advantageous in terms of manufacturing devices (see Japanese Patent No. 4185941). Such an imprint apparatus adopts the die-by-die alignment scheme as a scheme of alignment between a substrate and a mold. The die-by-die alignment scheme is an alignment scheme which optically detects marks, formed in a plurality of shot regions on the substrate, for each of these shot regions, and corrects a shift in positional relationship between the substrate and the mold. On the other hand, the global alignment scheme is common as an alignment scheme for an exposure apparatus including a projection optical system which projects the pattern of an original (reticle or mask) onto a substrate. The global alignment scheme is an alignment scheme which performs alignment in accordance with an index obtained by statistically processing the detection results of marks formed on several representative shot regions (sample shot regions) (that is, in accordance with the same index for all shot regions).

In the imprint apparatus, if the air, for example, remains in the pattern (grooves) of the mold upon bringing the resin on the substrate and the mold into contact with each other, distortion, for example, occurs in a pattern to be transferred onto the substrate, thus making it impossible to precisely transfer the pattern. In view of this, a technique of preventing the air from remaining in the pattern (grooves) of the mold by supplying a gas (for example, helium) with a high solubility in the resin on the substrate to the space between the substrate and the mold in pressing the mold against the resin has been proposed (see Japanese PCT National Publication No. 2007-509769).

Unfortunately, the shapes of marks formed in a shot region on the outer periphery of the substrate may deform due to factors of a process (for example, a polishing process (CMP)), such as film wear of the underlying layer. The die-by-die alignment scheme which uses even marks deformed as in this case may not be able to precisely align the substrate and the mold.

Also, in the global alignment scheme, alignment is performed based on an index obtained by a statistical process without detecting the marks formed in the shot regions in pressing the mold against the resin on the substrate. However, in the imprint apparatus, a positional shift and deformation may occur in the mold or the substrate due to a reaction force acting upon pressing the mold against the resin on the substrate. Therefore, even when alignment is performed by applying the global alignment scheme to the imprint apparatus, the substrate and the mold cannot be precisely aligned because the alignment result contains error components resulting from a positional shift and deformation with respect to their target positions.

Furthermore, in the imprint apparatus, a soluble gas which has a high solubility in the resin and is supplied to the space between the substrate and the mold may flow into the measurement optical path of an interferometer which measures the position of a stage which holds the substrate. When the soluble gas flows into the measurement optical path of the interferometer, the refractive index of the measurement optical path of the interferometer changes, so an error occurs in measurement of the stage position by the interferometer, thus degrading the accuracy of stage position control. This fact presents a serious disadvantage in terms of the global alignment scheme. Such a problem is posed not only in an imprint apparatus but also in a lithographic apparatus which suffers from degradation in accuracy of stage position control in transferring the pattern of an original onto a substrate.

### SUMMARY OF THE INVENTION

The present invention provides a lithographic apparatus advantageous in terms of alignment between an original and a substrate.

According to one aspect of the present invention, there is provided a lithographic apparatus which transfers a pattern of an original onto a substrate, the apparatus including a first detection unit configured to detect a first mark formed on the original and a second mark formed in each of a plurality of shot regions on the substrate, a second detection unit configured to detect the second mark formed in each of the plurality of shot regions, and a processing unit, wherein the processing unit performs a process of detecting the second mark by the second detection unit to obtain an array of the plurality of shot regions, a process of obtaining a positional relationship between the first mark and the second mark, which are detected by the first detection unit, for each of the plurality of shot regions upon moving the substrate using the result of obtaining the array of the plurality of shot regions, and a process of transferring the pattern of the original onto each of the plurality of shot regions upon aligning the original and the substrate for each of the plurality of shot regions so that the first mark and the second mark which are detected by the first detection unit have the positional relationship obtained for each of the plurality of shot regions.

Further features of the present invention will become apparent from the following description of exemplary embodiments with reference to the attached drawings.

### BRIEF DESCRIPTION OF THE DRAWINGS

FIG. 1 is a schematic diagram showing the arrangement of an imprint apparatus according to an aspect of the present invention.

FIG. 2 is a view schematically showing a shot region on a substrate.

FIG. 3 is a flowchart for explaining the operation of the imprint apparatus shown in FIG. 1.

FIG. 4 is a view for explaining calculation of global correction values in step S306 of FIG. 3.

FIG. 5 is a view schematically showing shot regions on the substrate.

FIG. 6 is a schematic diagram showing the arrangement of another imprint apparatus according to another aspect of the present invention.

FIG. 7 is a flowchart for explaining the operation of the imprint apparatus shown in FIG. 6.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

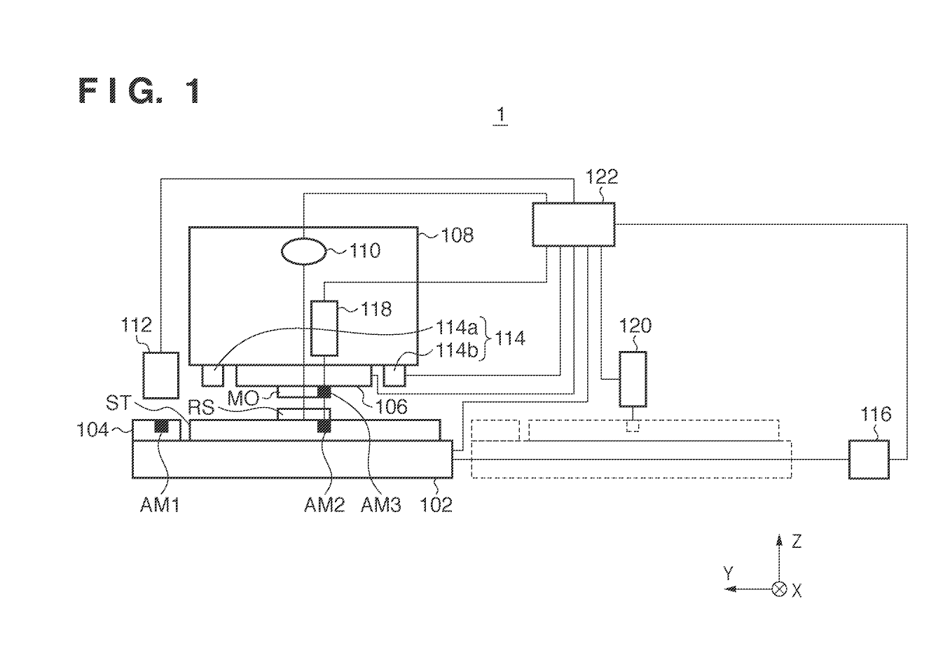

FIG. 1 is a schematic diagram showing the arrangement of an imprint apparatus 1 according to an aspect of the present invention. The imprint apparatus 1 is a lithographic apparatus which transfers the pattern of a mold serving as an original onto a substrate. The imprint apparatus 1 performs an imprint process of curing a resin supplied (dispensed) on the substrate, while the resin and the mold are kept in contact with each other, and separating the mold from the cured resin.

The imprint apparatus 1 includes a substrate stage 102, mold stage 106, structure 108, irradiation unit 110, resin supply unit 112, gas supply unit 114, interferometer 116, first detection unit 118, second detection unit 120, and control unit 122.

The substrate stage 102 holds (chucks by suction) a substrate ST such as a silicon wafer or a glass plate via a substrate chuck, and drives the substrate ST in the X- and Y-axis directions to position it at a predetermined position. Also, a reference member 104 which serves as a reference for the substrate stage 102 is disposed on the substrate stage 102, and an alignment mark AM1 is formed on the reference member 104.

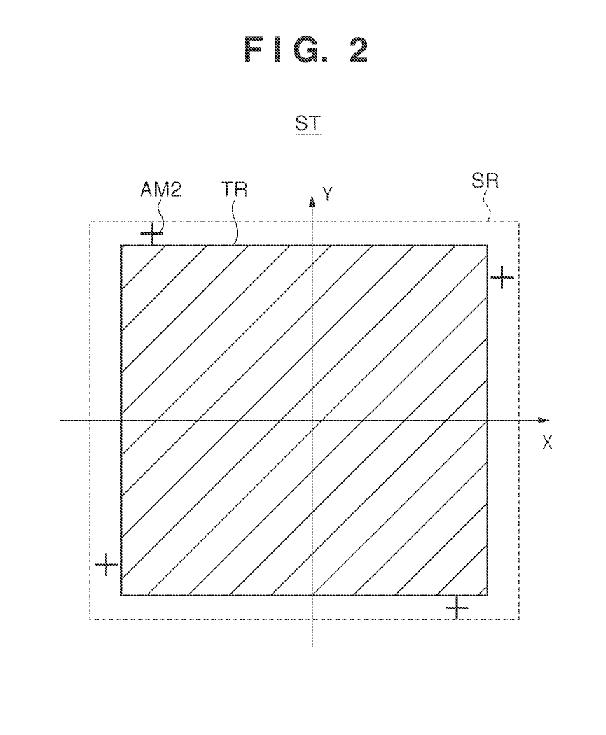

A plurality of shot regions onto which the pattern of a mold MO is to be transferred are arrayed on the substrate ST, and alignment marks (second marks) AM2 are formed to surround a pattern transfer region TR in each of a plurality of shot regions SR, as shown in FIG. 2. Note that FIG. 2 is a view schematically showing the shot region SR on the substrate ST.

The mold stage 106 is provided on the structure 108, and holds (chucks by suction) the mold MO via a mold chuck and drives the mold MO in the Z-axis direction. The mold stage 106 drives the mold MO in the negative Z-axis direction (downward direction), thereby pressing the mold MO against a resin RS on the substrate ST. Also, the mold stage 106 drives the mold MO in the positive Z-axis direction (upward direction), thereby separating the mold MO from the cured resin RS on the substrate ST.

The mold MO is made of a material which transmits light from the irradiation unit 110, and has a pattern surface on which a pattern (three-dimensional pattern) to be transferred onto the substrate ST is formed. Alignment marks (first marks) AM3 are formed on the mold MO at positions corresponding to the alignment marks AM2 formed in the shot region SR on the substrate ST.

The irradiation unit 110 is provided in the structure 108, includes a light source and an optical system including, for example, a lens, and irradiates the resin RS with light (ultraviolet rays) while the mold MO is pressed against the resin RS on the substrate ST (that is, via the mold MO).

The resin supply unit 112 includes a plurality of dispensers which discharge the resin RS as droplets, and supplies (dispenses) the resin RS onto the shot region SR (transfer region TR) on the substrate ST. More specifically, the resin RS is dispensed onto the substrate ST by driving the substrate stage 102 (by its scan or step driving) while discharging the resin RS from the dispensers which form the resin supply unit 112.

The gas supply unit 114 includes a supply port 114a which supplies a gas and a recovery port 114b which recovers the gas, and supplies a predetermined gas to the space between the substrate ST and the mold MO. A practical example of the predetermined gas is a soluble gas (for example, helium or carbon dioxide) with a high solubility in the resin RS. In pressing the mold MO against the resin RS on the substrate ST, that is, in performing an imprint process, the gas supply unit 114 supplies a soluble gas to the space between the substrate ST and the mold MO, thereby preventing the air from remaining in the pattern (grooves) of the mold MO. At this time, the gas supply unit 114 recovers the soluble gas, supplied to the space between the substrate ST and the mold MO, using the recovery port 114b, thereby preventing the soluble gas from flowing into the optical path (measurement optical path) for light emitted by the interferometer 116. Also, when the second detection unit 120 detects the alignment mark AM2, the gas supply unit 114 stops the supply of the soluble gas to the space between the substrate ST and the mold MO.

The interferometer 116 includes a light source for irradiating an interferometer mirror provided on the substrate stage 102 with light, and a light-receiving element for receiving the light reflected by the interferometer mirror, and measures the position of the substrate stage 102.

The first detection unit 118 detects the alignment mark AM3 formed on the mold MO, and detects the alignment mark AM2, formed in each of the plurality of shot regions SR on the substrate ST, via the mold MO. In other words, the first detection unit 118 detects the relative positional relationship between the mold MO (alignment mark AM3) and the substrate ST (alignment mark AM2). The first detection unit 118 includes, for example, a sensor which detects an interference signal from the alignment marks AM2 and AM3 and a signal obtained by a synergetic effect such as moire.

The second detection unit 120 detects the alignment mark AM2, formed in each of the plurality of shot regions SR on the substrate ST, without using the mold MO. Note that the second detection unit 120 is placed at a position spaced apart from the structure 108 and mold MO, as shown in FIG. 1, so the substrate stage 102 which holds the substrate ST must be moved (driven) to a position indicated by a broken line, in detecting the alignment mark AM2. The second detection unit 120 includes, for example, a sensor which detects the alignment mark AM2 in the form of an image via an imaging optical system.

An example in which both the first detection unit 118 and the second detection unit 120 detect the same pattern of the alignment mark AM2 will be explained herein. However, patterns which are uniquely suitable for the first detection unit 118 and second detection unit 120 may be formed to allow the respective detection units to detect these different patterns.

The control unit 122 includes a CPU and memory and functions as a processing unit which preforms each process (processes for transferring the pattern of the mold MO onto the substrate ST) of the imprint apparatus 1 (that is, the control unit 122 operates the imprint apparatus 1). For example, the control unit 122 controls the position of the substrate stage 102 based on, for example, the measurement result obtained by the interferometer 116 and the detection results obtained by the first detection unit 118 and second detection unit 120, respectively. Note that the imprint apparatus 1 prevents the soluble gas supplied from the gas supply unit 114 from flowing into the measurement optical path of the interferometer 116, as described above. However, because the space between the substrate ST and the mold MO is not tightly sealed, a very small amount of soluble gas may flow into the measurement optical path of the interferometer 116. This does not always make it impossible to control the position of the substrate stage 102 in performing an imprint process, but nonetheless makes it difficult to control the position of the substrate stage 102 with the accuracy required for the manufacture of devices. On the other hand, in detecting the alignment mark AM2 by the second detection unit 120, the supply of the soluble gas from the gas supply unit 114 is stopped and the substrate stage 102 is placed at a position spaced apart from the space between the substrate ST and the mold MO, as described above. In this case, therefore, the position of the substrate stage 102 can be controlled with high accuracy as the soluble gas does not flow into the measurement optical path of the interferometer 116. In this manner, in the imprint apparatus 1, the accuracy of position control of the substrate stage 102 is lower when the first detection unit 118 detects the alignment mark AM2 than when the second detection unit 120 detects the alignment mark AM2.

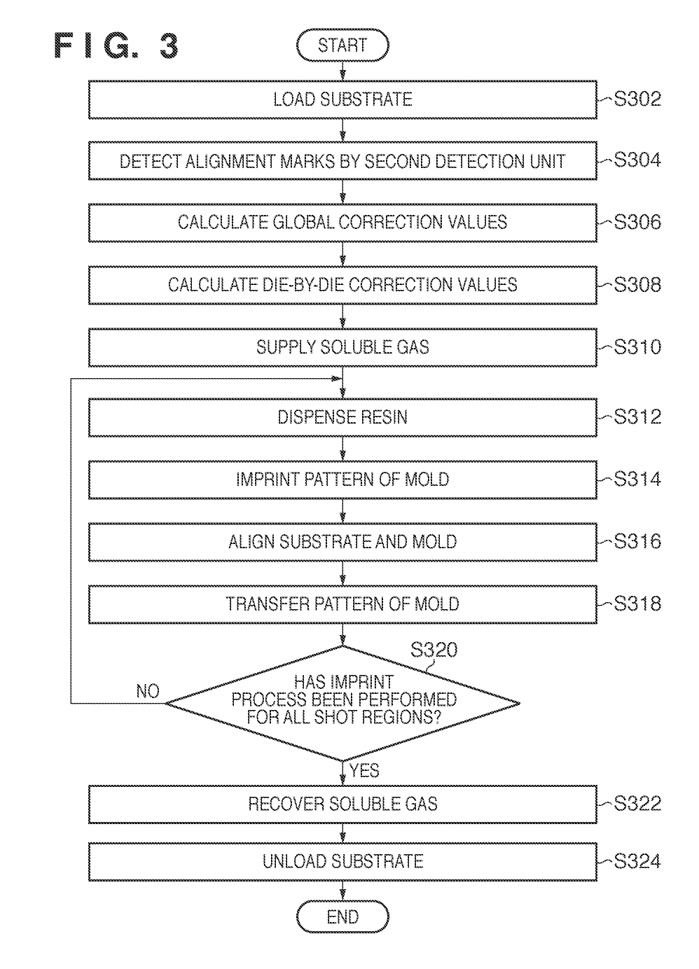

The operation of the imprint apparatus 1, that is, an imprint process of transferring the pattern of the mold MO onto the substrate ST will be described below with reference to FIG. 3. The operation of the imprint apparatus 1, shown in FIG. 3, is performed by systematically controlling each unit of the imprint apparatus 1 by the control unit 122.

The imprint apparatus 1 in this embodiment adopts a new alignment scheme which combines the global alignment scheme and the die-by-die alignment scheme as a scheme of alignment between the substrate ST and the mold MO. In the conventional die-by-die alignment scheme, the first detection unit 118 detects the alignment marks AM2 and AM3 for each shot on the substrate ST. Then, the substrate stage 102 is driven to align the substrate ST and the mold MO so that the positions of the alignment marks AM2 and AM3 coincide (are overlaid) with each other. Therefore, if the positions of the alignment marks AM2 and AM3 detected by the first detection unit 118 contain errors due to factors associated with the underlying layer of the substrate ST, the substrate ST and the mold MO cannot be precisely aligned. On the other hand, in the conventional global alignment scheme, a positional shift and deformation occur in the substrate ST and the mold MO upon pressing the mold MO against the resin on the substrate ST, so the substrate ST and the mold MO cannot be precisely aligned. Also, the accuracy of position control of the substrate stage 102 is lower in performing an imprint process than in detecting the alignment marks AM2 formed in sample shot regions, as described above. In this case, therefore, even when alignment is performed in accordance with an index obtained by statistically processing the detection results of the alignment marks AM2 formed in sample shot regions, the substrate ST and the mold MO cannot be precisely aligned because the accuracy of position control of the substrate stage 102 in performing an imprint process is relatively low.

In view of this, in the alignment scheme of this embodiment, first, the position of the alignment mark formed in each shot region is obtained in advance by statistically processing the detection results of the alignment marks formed in sample shot regions, as in the global alignment scheme. Next, the difference between the position of the alignment mark obtained by the statistical process and the detected position of the alignment mark is obtained for each of a plurality of shot regions on the substrate. The positional relationship between the mold and the substrate is adjusted so that the amount of shift between the position of the alignment mark formed on the mold and that of the alignment mark formed in each shot region becomes equal to the obtained difference. Note that in this embodiment, there is no need to control the position of the substrate stage with high accuracy in performing an imprint process, because the position of the substrate stage is adjusted while detecting the position of the mold (the alignment mark formed on it) and that of the substrate (the alignment mark formed on it).

In step S302, a substrate ST onto which the pattern of the mold MO is to be transferred is loaded into the imprint apparatus 1 and is held on the substrate stage 102.

In step S304, the substrate stage 102 (substrate ST) is moved (driven) to fall within the field of view (a position indicated by a broken line in FIG. 1) of the second detection unit 120, and the second detection unit 120 detects alignment marks AM2 formed in each of a plurality of shot regions SR on the substrate ST. At this time, the position of the substrate stage 102 is controlled based on the measurement result obtained by the interferometer 116, so the measurement accuracy of the interferometer 116 serves as a reference for the accuracy of position control of the substrate stage 102 by global alignment. Hence, while the second detection unit 120 detects the alignment marks AM2, it is effective to eliminate deformation and vibration of a surface plate which supports the interferometer 116 and fluctuations in length measurement space, and it is effective to use, for example, a plane encoder in place of the interferometer 116.

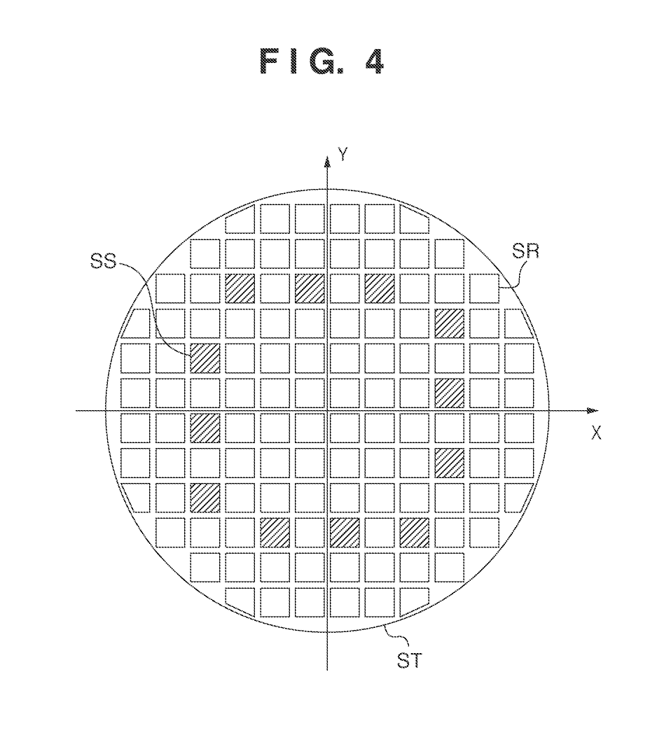

In step S306, the detection results of the alignment marks AM2 obtained by the second detection unit 120 are statistically processed to calculate statistics representing an array of a plurality of shot regions SR on the substrate ST, that is, global correction values (indices). Global correction values can be calculated in the same way as in the conventional global alignment scheme. For example, as shown in FIG. 4, several shot regions in which the alignment marks AM2 have less deterioration among the plurality of shot regions SR on the substrate ST are selected (set) as sample shot regions SS in advance. Global correction values are calculated from the detection results of the alignment marks AM2 formed in each of the sample shot regions SS, which are obtained by the second detection unit 120. Note that the global correction values include at least one of the shift components, magnification components, and rotational components of each of the plurality of shot regions SR on the substrate ST.

Calculation of global correction values will be explained in detail herein. In this embodiment, a design position (X_{c}, Y_{c}) and detected position (P_{cx}, P_{cy}) of the center position of each shot region are assumed to approximately satisfy relations:

P_{cx}=Sₓ+MₓX_{c}+RₓY_{c} (1)

P_{cy}=S_{y}+R_{y}X_{c}+M_{y}Y_{c} (2)

From equations (1) and (2) (their coefficients), shift components (Sₓ, S_{y}), magnification components (Mₓ, M_{y}), and rotational components (Rₓ, R_{y}) which are statistics representing an array of a plurality of shot regions SR on the substrate ST are calculated as global correction values. More specifically, the coefficients in equations (1) and (2) are obtained by the known least squares method using the design position (X_{c}, Y_{c}) and detected position (P_{cx}, P_{cy}) of the center position of each sample shot region. Note that the detected position (P_{cx}, P_{cy}) of the center position of each sample shot region is the average of the amounts of shift (the amounts of shift from the design positions) as the detection results of the alignment marks AM2, which are obtained by the second detection unit 120, and is calculated by:

$$\begin{matrix}{P}_{cx} = \frac{{\sum }_{j = 1}^{Nj} ( {X}_{m} [ j ] - {P}_{mx} [ j ] )}{{N}_{j}} + {X}_{c} & ( 3 ) \\ {P}_{cy} = \frac{{\sum }_{j = 1}^{Nj} ( {Y}_{m} [ j ] - {P}_{my} [ j ] )}{{N}_{j}} + {Y}_{c} & ( 4 )\end{matrix}$$

where (Xₘ[j], Yₘ[j]) is the design position of the j-th alignment mark AM2, (Pₘₓ[j], P_{my}[j]) is the detected position of the j-th alignment mark AM2, (X_{c}, Y_{c}) is the design position of the center position of each sample shot region, and Nⱼ is the number of alignment marks AM2 formed in this sample shot region.

In step S308, the difference between the position of the alignment mark AM2 obtained from the global correction values and that of the alignment mark AM2 detected by the second detection unit 120 in step S304, that is, die-by-die correction values are calculated. Note that die-by-die correction values are calculated for each of the plurality of shot regions SR on the substrate ST.

Calculation of die-by-die correction values will be explained in detail herein. First, based on the global correction values, a position (Qₓ, Q_{y}) of the alignment mark AM2 formed in each of the plurality of shot regions SR on the substrate ST is obtained by:

Qₓ=Sₓ+MₓX_{c}+RₓY_{c}+Xₛₘ (5)

Q_{y}=S_{y}+R_{y}X_{c}+M_{y}Y_{c}+Yₛₘ (6)

where (Sₓ, S_{y}, Mₓ, M_{y}, Rₓ, R_{y}) is the set of global correction values calculated in step S306, and (Xₛₘ, Yₛₘ) is the design position of the alignment mark AM2 from the center of each shot region in a coordinate system shown in FIG. 2.

Die-by-die correction values (Dₓ, D_{y}) representing the difference between the position (Qₓ, Q_{y}) of the alignment mark AM2 obtained from equations (5) and (6) and the detected position (Pₘₓ, P_{my}) of the alignment mark AM2 are calculated by:

Dₓ=Pₘₓ−Qₓ (7)

Dₓ=P_{my}−Q_{y} (8)

In this manner, global correction values and die-by-die correction values are calculated from the detection result obtained by the second detection unit 120 when the supply of the soluble gas from the gas supply unit 114 is stopped and the substrate stage 102 is placed at a position spaced apart from the gas supply unit 114. In other words, global correction values and die-by-die correction values are calculated based on the detection result obtained by the second detection unit 120 when the position of the substrate stage 102 is controlled with high accuracy.

In step S310, the substrate stage 102 which holds the substrate ST is moved to a position below the mold MO, and the gas supply unit 114 supplies a soluble gas to the space between the substrate ST and the mold MO. More specifically, while a soluble gas is supplied from the supply port 114a of the gas supply unit 114 to the space between the substrate ST and the mold MO, it is recovered from the recovery port 114b of the gas supply unit 114.

In step S312, the resin supply unit 112 dispenses (supplies) a resin RS onto a target shot region (a shot region onto which the pattern of the mold MO is to be transferred next) on the substrate ST.

In step S314, the mold MO is driven downward to press the mold MO against the resin RS dispensed on the target shot region on the substrate ST (the pattern of the mold MO is imprinted).

In step S316, the substrate ST and the mold MO are aligned. More specifically, the first detection unit 118 detects the alignment mark AM3 formed on the mold MO and the alignment mark AM2 formed in the target shot region on the substrate ST. The positional relationship between the substrate ST and the mold MO is adjusted so that the amount of shift between the alignment mark AM3 formed on the mold MO and the alignment mark AM2 formed in the target shot region becomes equal to the die-by-die correction values for the target shot region, which are calculated in step S308. In other words, the positional relationship between the substrate ST and the mold MO is adjusted so that the alignment mark AM3 formed on the mold MO and the alignment mark AM2 formed in the target shot region shift from each other by the die-by-die correction values. Note that a target amount of shift (Tₓ, T_{y}) in the alignment between the substrate ST and the mold MO is given by:

Tₓ=Dₓ−(P_{wx}−Pₜₓ) (9)

T_{y}=D_{y}−(P_{wy}−P_{ty}) (10)

where (Pₜₓ, P_{ty}) is the detected position of the alignment mark AM3 formed on the mold MO, and (Pₘₓ, P_{my}) is the detected position of the alignment mark AM2 formed in the target shot region.

Note that in step S316, the position of the substrate stage 102 is feedback-controlled based on the detection results of the alignment marks AM2 and AM3 obtained by the first detection unit 118. Therefore, even if an error occurs in the interferometer 116 as a soluble gas supplied from the gas supply unit 114 flows into the optical path for light emitted by the interferometer 116, this never adversely affects the alignment accuracy between the substrate ST and the mold MO. In this embodiment, after the mold MO is pressed against the resin RS dispensed on the target shot region, the substrate ST and the mold MO are aligned. However, the substrate ST and the mold MO may be aligned while keeping them in proximity to each other (that is, without pressing the mold MO against the resin RS).

In step S318, the pattern of the mold MO is transferred onto the target shot region on the substrate ST. More specifically, while the mold MO is pressed against the resin RS dispensed on the target shot region, the irradiation unit 110 irradiates the resin RS with light to cure the resin RS. Then, the mold MO is driven upward to separate the mold MO from the cured resin RS, thereby transferring the pattern of the mold MO onto the target shot region.

In step S320, it is determined whether transfer of the pattern of the mold MO (an imprint process) has been performed for all shot regions on the substrate ST. If an imprint process has not yet been performed for all shot regions on the substrate ST, the process returns to step S312, in which the resin RS is dispensed onto the next shot region (target shot region) onto which the pattern of the mold MO is to be transferred. On the other hand, if an imprint process has already been performed for all shot regions on the substrate ST, the process advances to step S322.

In step S322, the soluble gas supplied to the space between the substrate ST and the mold MO by the gas supply unit 114 is recovered. More specifically, the supply of the soluble gas from the supply port 114a of the gas supply unit 114 is stopped, and the soluble gas supplied to the space between the substrate ST and the mold MO is recovered from the recovery port 114b of the gas supply unit 114.

In step S324, the substrate ST in which the pattern of the mold MO has been transferred onto all shot regions is unloaded from the imprint apparatus 1, and the operation ends.

In this manner, in this embodiment, in an imprint process, the positional relationship between the substrate ST and the mold MO is adjusted so that the positions of the alignment marks AM3 and AM2 detected by the first detection unit 118 shift from each other by the die-by-die correction values. In other words, an error of the position of the alignment mark AM2 detected by the first detection unit 118 is corrected by the die-by-die correction values. Therefore, the imprint apparatus 1 can align the substrate ST and the mold MO with high accuracy.

In the flowchart shown in FIG. 3, only shift components are corrected assuming that the magnification components and rotational components of each shot region conform to design values. Hence, only statistics representing the position of each sample shot region with respect to the design position of this sample shot region are calculated as global correction values, but the present invention is not limited to this. The present invention is also applicable when, for example, magnification components and rotational components are corrected for each shot region on the substrate. In the following description, statistics representing the position and shape of each sample shot region with respect to the design position of this sample shot region are calculated.

To calculate, as global correction values, statistics representing the position and shape of each sample shot region with respect to the design position of this sample shot region, first and second statistical processes to be described below are performed. In the first statistical process, the position and shape (statistics) of each sample shot region are calculated from the detected position of the alignment mark AM2 formed in this sample shot region. In the second statistical process, the positions and shapes of all shot regions on the substrate are calculated (estimated) from the position and shape of each sample shot region calculated in the first statistical process.

In the first statistical process, the center of each shot region in a coordinate system shown in FIG. 2 is defined as an origin, and a design position (Xₘₛ, Yₘₛ) and detected position (Pₘₓ, P_{my}) of the alignment mark AM2 are assumed to approximately satisfy relations:

Pₘₓ=Sₛₓ+MₛₓXₘₛ+RₛₓYₘₛ (11)

Pₘₓ=S_{sy}+R_{sy}Xₘₛ+M_{sy}Yₘₛ (12)

From equations (11) and (12) (their coefficients), shift components (Sₛₓ, S_{sy}), magnification components (Mₛₓ, M_{sy}), and rotational components (Rₛₓ, R_{sy}) which are statistics representing the arrangement of sample shot regions are calculated. More specifically, the coefficients in equations (11) and (12) are obtained by the known least squares method using the detected position of the center position of each sample shot region.

In the second statistical process, the center position of the substrate ST in a coordinate system shown in FIG. 4 is defined as an origin. Then, the design position (X_{c}, Y_{c}) of the center position of each shot region, and the shift components (Sₓ, S_{y}), magnification components (Mₛₓ, M_{sy}), and rotational components (Rₛₓ, R_{sy}) of this shot region are assumed to approximately satisfy relations:

Sₛₓ(X_{c},Y_{c})=aₛₓ+bₛₓX_{cx}+cₛₓY_{cy}+dₛₓX_{c}²+eₛₓX_{c}Y_{c}+fₛₓY_{c}²+gₛₓX_{c}³+hₛₓX_{c}²Y_{c}+iₛₓX_{c}Y_{c}²+jₛₓY_{c}³+ (13)

S_{sy}(X_{c},Y_{c})=a_{sy}+b_{sy}X_{c}+c_{sy}Y_{c}+d_{sy}X_{c}²+e_{sy}X_{c}Y_{c}+f_{sy}Y_{c}²+g_{sy}X_{c}³+h_{sy}X_{c}²Y_{c}+i_{sy}X_{c}Y_{c}²+j_{sy}Y_{c}³+ (14)

Mₛₓ(X_{c},Y_{c})=aₘₓ+bₘₓX_{c}+cₘₓY_{c}+dₘₓX_{c}²+eₘₓX_{c}Y_{c}+fₘₓY_{c}²+gₘₓX_{c}³+hₘₓX_{c}²Y_{c}+iₘₓX_{c}Y_{c}²+jₘₓY_{c}³+ (15)

Mₛₓ(X_{c},Y_{c})=a_{my}+b_{my}X_{c}+c_{my}Y_{c}+d_{my}X_{c}²+e_{my}X_{c}Y_{c}+f_{my}y₂²+g_{my}X_{c}³+h_{my}X_{c}²Y_{c}+i_{my}X_{c}Y_{c}²+j_{my}Y_{c}³+ (16)

Rₛₓ(X_{c},Y_{c})=aᵣₓ+bᵣₓX_{c}+cᵣₓY_{c}+dᵣₓX_{c}²+eᵣₓX_{c}Y_{c}+fᵣₜₓY_{c}²+gᵣₓX_{c}³+hᵣₓX_{c}²Y_{c}+iᵣₓX_{c}Y_{c}²+jᵣₓY_{c}³+ (17)

R_{sy}(X_{c},Y_{c})=a_{ry}+b_{ry}X_{c}+c_{ry}Y_{c}+d_{ry}X_{c}²+e_{ry}X_{c}Y_{c}+f_{ry}Y_{c}²+g_{ry}X_{c}³+h_{ry}X_{c}²Y_{c}+i_{ry}X_{c}Y_{c}²+j_{ry}Y_{c}³+ (18)

The coefficients in equations (13) to (18) are obtained as global correction values. More specifically, the coefficients aₛₓ to jₛₓ, a_{sy} to j_{sy}, aₘₓ to jₘₓ, a_{my} to j_{my}, aᵣₓ to jᵣₓ, and a_{ry} to j_{ry} are calculated based on the statistics Sₛₓ, S_{sy}, Mₛₓ, M_{sy}, Rₛₓ, and R_{sy}, respectively, of each sample shot region.

The position (Qₓ, Q_{y}) of the alignment mark AM2 is obtained from the statistics (Sₛₓ, S_{sy}, Mₛₓ, M_{sy}, Rₛₓ, R_{sy}) representing the positions and shapes of all shot regions on the substrate ST, and the design position (Xₘₛ, Yₘₛ) of the alignment mark AM2. More specifically, a position (Qₓ, Q_{y}) of the alignment mark AM2 is obtained using:

Qₓ=Sₛₓ+MₛₓXₘₛ+RₛₓYₘₛ+X_{c} (19)

Q_{y}=S_{sy}+R_{sy}Xₘₛ+M_{sy}Yₘₛ+Y_{c} (20)

Die-by-die correction values (Dₓ, D_{y}) representing the difference between the position (Qₓ, Q_{y}) of the alignment mark AM2 obtained from equations (19) and (20) and the detected position (Pₘₓ, P_{my}) of the alignment mark AM2 are calculated by equations (7) and (8).

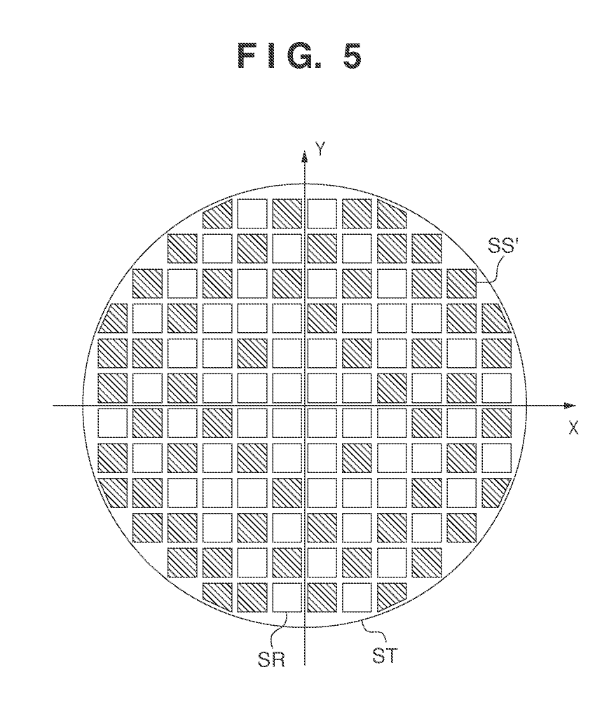

In the above description, to calculate die-by-die correction values, the alignment marks AM2 formed in all shot regions on the substrate ST (their positions) are detected. However, die-by-die correction values can also be calculated by detecting only the alignment marks AM2 formed in some of the plurality of shot regions SR on the substrate ST. For example, as shown in FIG. 5, the alignment marks AM2 in shot regions SS′ which are larger in number than sample shot regions SS shown in FIG. 4 can be detected to obtain approximations of an order higher than that of approximations presented in equations (1) and (2) (equations (11) and (12)). More specifically, letting (Pₘₓ, P_{my}) be the detected position of the alignment mark AM2 formed in a given shot region on the substrate ST, and (Xₘ, Yₘ) be the design position of the alignment mark AM2 formed in the given shot region, the detected position (Pₘₓ, P_{my}) and design position (Xₘ, Yₘ) are assumed to approximately satisfy relations:

Pₘₓ=aₓ+bₓXₘ+cₓYₘ+dₓXₘ²+eₓXₘYₘ+fₓYₘ²+gₓXₘ³+hₓXₘ²Yₘ+iₓXₘy₂²+jₓYₘ³+ (21)

P_{my}=a_{y}+b_{y}Xₘ+c_{y}Yₘ+d_{y}Xₘ²+e_{y}XₘYₘ+f_{y}Yₘ²+g_{y}Xₘ³+h_{y}Xₘ²Yₘ+i_{y}Xₘy₂²+j_{y}Yₘ³+ (22)

Also, the coefficients aₓ to jₓ and a_{y} to j_{y} in equations (21) and (22) are calculated using the known least squares method, based on the detected positions and design positions of the alignment marks AM2 formed in some shot regions SS′ among the plurality of shot regions SR on the substrate ST. The detected position (Pₘₓ, P_{my}) of the alignment mark AM2 is obtained by substituting the design positions of the alignment marks AM2 formed in the remaining shot regions into equations (21) and (22).

Although an imprint apparatus which supplies a predetermined gas to the space between a substrate and a mold in transferring the pattern of the mold onto the substrate has been taken as an example in this embodiment, the present invention is not limited to a specific imprint apparatus as mentioned above. The present invention is also effective for, for example, an imprint apparatus which controls the position of a substrate stage with an accuracy that is lower in an imprint process than in other processes (a process of detecting alignment marks by a second detection unit). Note that a gas supply unit and resin supply unit are disposed near the mold, as shown in FIG. 1, so it is difficult to dispose, near the mold, a plane encoder for measuring the position of the substrate stage with higher accuracy or other devices. On the other hand, since a wider spatial margin is available in the vicinity of the second detection unit than in the vicinity of the mold, a plane encoder or other devices can be disposed near the second detection unit.

The present invention is moreover applicable to a lithographic apparatus other than an imprint apparatus, such as an exposure apparatus which performs an exposure process of projecting the pattern of a reticle (mask) serving as an original onto a plurality of shot regions on a substrate by a projection optical system. In the exposure apparatus, it is difficult to dispose, near the projection optical system, a measurement device for measuring the position of a substrate stage with higher accuracy, but it is possible to dispose this measurement device near an off-axis detection system corresponding to the second detection unit. In this manner, the present invention is effective for an exposure apparatus which controls the position of a substrate stage with an accuracy that is lower in performing an exposure process than in performing a detection process using an off-axis detection system.

In this embodiment, alignment mark detection for obtaining global correction values and die-by-die correction values is performed at a position (a position other than the vicinity of the mold) that is less likely to be adversely affected by the predetermined gas supplied from the gas supply unit. However, when the predetermined gas can be sufficiently recovered, that is, when a given accuracy of position control of the substrate stage can be maintained even at a position below the mold, the first detection unit may perform alignment mark detection for obtaining global correction values and die-by-die correction values.

The imprint apparatus 1 shown in FIG. 1 obtains die-by-die correction values from the detection result of the alignment mark AM2 obtained by the second detection unit 120. In such a case, the first detection unit 118 (its constituent sensor) and the second detection unit 120 (its constituent sensor) must have nearly the same detection characteristics. However, the first detection unit 118 must detect both the alignment marks AM2 and AM3 at once and therefore must be set in only a narrow space in the structure 108, resulting in a large number of design constraints (for example, the practically attainable numerical aperture (NA) has an upper limit). Therefore, matching the detection characteristics of the second detection unit 120 with those of the first detection unit 118 is disadvantageous in terms of the detection accuracy with which the second detection unit 120 detects the alignment mark AM2 to obtain global correction values.

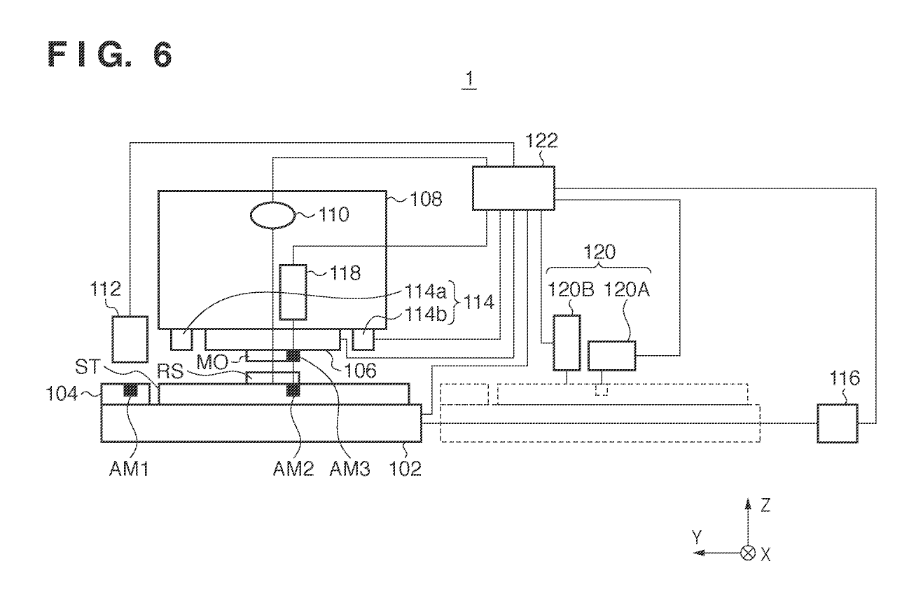

In view of this, as shown in FIG. 6, the second detection unit 120 is formed from a first sensor 120A having detection characteristics different from those of the first detection unit 118 (its constituent sensor), and a second sensor 120B having the same detection characteristics as those of the first detection unit 118. The first sensor 120A has detection characteristics that are more excellent than those of the first detection unit 118, and, for example, detects the alignment mark AM2 in the form of an image via an imaging optical system. Also, the second sensor 120B detects an interference signal and a signal obtained by a synergetic effect such as moire, like the first detection unit 118. Note that the second detection unit 120 detects signals from the alignment mark AM2 and a mark formed inside it, in place of the alignment mark AM3 formed on the mold MO. Although the second detection unit 120 has a more complex arrangement in the imprint apparatus 1 shown in FIG. 6, the design constraints on the first sensor 120A can be relaxed. Therefore, the imprint apparatus 1 shown in FIG. 6 can be provided with the first sensor 120A which is advantageous in terms of the detection accuracy with which it detects the alignment mark AM2 (that is, which is capable of detecting the alignment mark AM2 with high accuracy). Nevertheless, it is necessary in this case to detect, in advance, the alignment mark AM1 formed on the reference member 104 on the substrate stage 102 by the first sensor 120A and second sensor 120B to obtain the distance between the first sensor 120A and the second sensor 120B in advance.

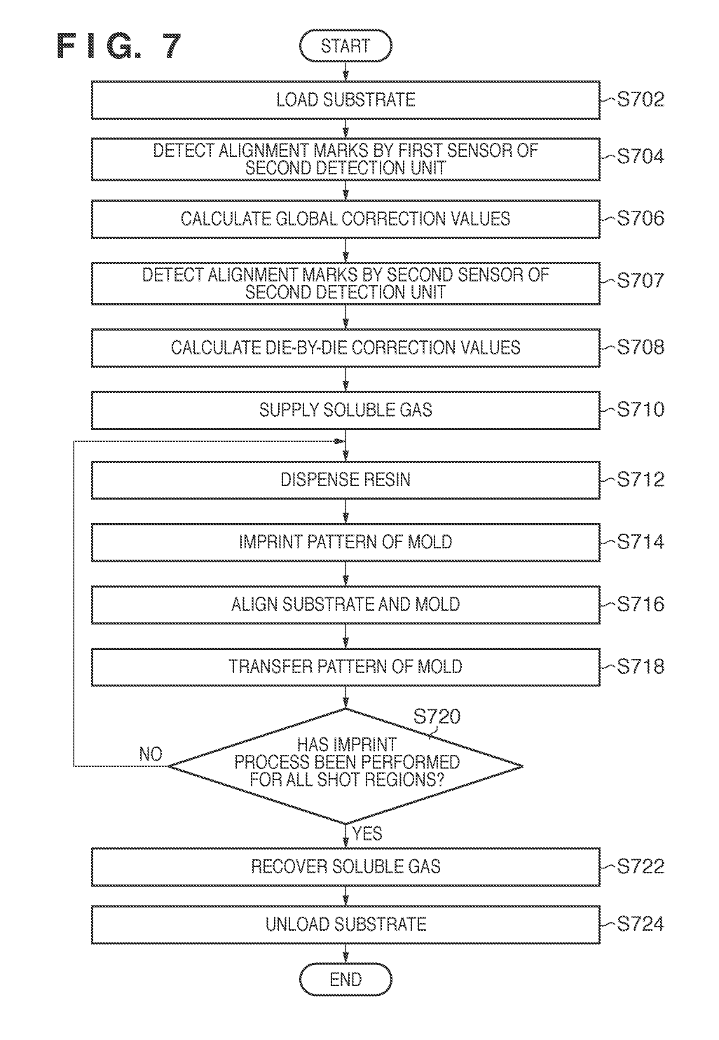

The operation of the imprint apparatus 1 shown in FIG. 6, that is, an imprint process of transferring the pattern of the mold MO onto the substrate ST will be described below with reference to FIG. 7. The operation of the imprint apparatus 1, shown in FIG. 7, is performed by systematically controlling each unit of the imprint apparatus 1 by the control unit 122.

In step S702, a substrate ST onto which the pattern of the mold MO is to be transferred is loaded into the imprint apparatus 1 and is held on the substrate stage 102.

In step S704, the substrate stage 102 which holds the substrate ST is moved to fall within the field of view (a position indicated by a broken line in FIG. 6) of the first sensor 120A of the second detection unit 120, and the first sensor 120A detects alignment marks AM2. Although the alignment marks AM2 formed in the plurality of shot regions SR on the substrate ST are detected in step S304, alignment marks AM2 formed in sample shot regions among a plurality of shot regions SR on the substrate ST need only be detected in step S704.

In step S706, the detection results of the alignment marks AM2 obtained by the first sensor 120A of the second detection unit 120 are statistically processed to calculate statistics representing an array of a plurality of shot regions SR on the substrate ST, that is, global correction values. As described above, because the first sensor 120A has detection characteristics that are more excellent than those of the first detection unit 118, global correction values with a precision higher than those calculated in step S306 can be calculated in step S706.

In step S707, the second sensor 120B of the second detection unit 120 detects the alignment marks AM2 for all shot regions on the substrate ST.

In step S708, the difference between the position of the alignment mark AM2 obtained from the global correction values and that of the alignment mark AM2 detected by the second sensor 120B of the second detection unit 120 in step S707, that is, die-by-die correction values are calculated. As described above, because the global correction values calculated in step S706 have a precision higher than those calculated in step S306, the die-by-die correction values calculated in step S708, in turn, have a precision higher than those calculated in step S308.

The imprint apparatus 1 shown in FIG. 6 calculates global correction values using the detection result obtained by the first sensor 120A of the second detection unit 120, and die-by-die correction values using the detection result obtained by the second sensor 120B of the second detection unit 120.

Note that the processes in steps S710 to S724 are the same as those in steps S310 to S324, respectively, and a detailed description thereof will not be given herein.

In this manner, since the imprint apparatus 1 shown in FIG. 6 can obtain global correction values and die-by-die correction values with higher precision, it can align the substrate ST and the mold MO with high accuracy.

A manufacturing method of devices (such as a semiconductor integrated circuit element and a liquid crystal display element) as commodities includes a step of transferring (forming) a pattern on a substrate (such as a wafer, a glass plate, and a film substrate) using the imprint apparatus 1 or 1A. The manufacturing method further includes a step of etching the substrate with the transferred pattern. In place of the etching step, the manufacturing method includes another processing step of processing the substrate with the transferred pattern to manufacture other commodities, such as pattern dot media (recording media) and optical elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2010-124614 filed on May 31, 2010, which is hereby incorporated by reference herein in its entirety.

What is claimed is:

1. A lithographic apparatus which transfers a pattern of an original onto a substrate, the apparatus comprising:
a first detection unit configured to detect a first mark formed on the original and a second mark formed in each of a plurality of shot regions on the substrate;
a second detection unit configured to detect the second mark formed in each of the plurality of shot regions; and
a processing unit,
wherein said processing unit performs
a process of detecting the second mark by said second detection unit to obtain an array of the plurality of shot regions,
a process of obtaining a positional relationship between the first mark and the second mark, which are detected by said first detection unit, for each of the plurality of shot regions upon moving the substrate using the result of obtaining the array of the plurality of shot regions, and
a process of transferring the pattern of the original onto each of the plurality of shot regions upon aligning the original and the substrate for each of the plurality of shot regions so that the first mark and the second mark which are detected by said first detection unit have the positional relationship obtained for each of the plurality of shot regions.

2. The apparatus according to claim 1, wherein
said second detection unit includes a first sensor having a detection characteristic different from a detection characteristic of a sensor which forms said first detection unit, and a second sensor having a detection characteristic identical to the detection characteristic of the sensor which forms said first detection unit, and
said processing unit
detects the second mark by said first sensor and said second sensor as the process of detecting the second mark,
performs a process of detecting the second mark by said first sensor to obtain an array of the plurality of shot regions, and
a process of obtaining a difference between a position of the second mark formed in each of the plurality of shot regions, which is obtained from the array of the plurality of shot regions, and a position of the second mark detected by said second sensor, for each of the plurality of shot regions as the process of obtaining the positional relationship.

3. The apparatus according to claim 1, further comprising
a measurement device configured to measure a position of a substrate stage which holds the substrate,
wherein said processing unit
controls the position of the substrate stage using said measurement device in detecting the second mark by said second detection unit,
controls the position of the substrate stage using said measurement device in detecting the first mark and the second mark by said first detection unit, and
an accuracy of position control of the substrate stage is lower in detecting the first mark and the second mark by said first detection unit than in detecting the second mark by said second detection unit.

4. The apparatus according to claim 3, wherein said measurement device includes an interferometer.

5. The apparatus according to claim 1, wherein said processing unit performs an imprint process of curing a resin supplied on the substrate, while the resin and the pattern of the original are kept in contact with each other, and separating the original from the cured resin, as the process of transferring the pattern of the original onto each of the plurality of shot regions.

6. The apparatus according to claim 5, further comprising
a supply unit configured to supply a predetermined gas to a space between the original and the substrate,
wherein said supply unit
supplies the gas to the space while said processing unit performs the imprint process, and
stops the supply of the gas to the space while said processing unit performs the process of detecting the second mark by said second detection unit.

7. The apparatus according to claim 1, wherein said processing unit performs an exposure process of projecting the pattern of the original onto each of the plurality of shot regions by a projection optical system, as the process of transferring the pattern of the original onto each of the plurality of shot regions.

8. The apparatus according to claim 1, wherein the array of the plurality of shot regions includes at least one of a shift component, a magnification component, and a rotational component of each of the plurality of shot regions.

9. A manufacturing method of commodities comprising:
a step of using a lithography apparatus to form a pattern on a substrate; and
a step of processing the substrate with the pattern,
wherein the lithography apparatus which transfers a pattern of an original onto the substrate and includes
a first detection unit configured to detect a first mark formed on the original and a second mark formed in each of a plurality of shot regions on the substrate;
a second detection unit configured to detect the second mark formed in each of the plurality of shot regions; and
a processing unit,
wherein said processing unit performs
a process of detecting the second mark by said second detection unit to obtain an array of the plurality of shot regions,
a process of obtaining a positional relationship between the first mark and the second mark, which are detected by said first detection unit, for each of the plurality of shot regions upon moving the substrate using the result of obtaining the array of the plurality of shot regions, and
a process of transferring the pattern of the original onto each of the plurality of shot regions upon aligning the original and the substrate for each of the plurality of shot regions so that the first mark and the second mark which are detected by said first detection unit have the positional relationship obtained for each of the plurality of shot regions.
